(19) United States
(12) Patent Application Publication
(10) Pub. No.: US 2006/0048816 A1
(43) Pub. Date: Mar. 9, 2006

(54) Weldable mount for fuel system component

(76) Inventors: Michael S. Brock, Connersville, IN (US); J. Bradley Groom, Oxford, OH (US); Brian J. Williamson, Hagerstown, IN (US)

Correspondence Address: BARNES & THORNBURG, 11 SOUTH MERIDIAN, INDIANAPOLIS, IN, 46204, US

(21) Appl. No.: 10/937,170

(22) Filed: Sep. 9, 2004

(51) Int. Cl. F16K 24/04

(52) U.S. Cl. 137/202

(57) ABSTRACT

A vent apparatus includes a venting outlet and a tank mount adapted to support the venting outlet in communication with a mounting aperture formed in a fuel tank. The tank mount is made of a weldable plastics material.

### BACKGROUND

The present disclosure relates to a fuel system component, and particularly to a fuel tank valve assembly for venting a fuel tank made of a polymeric material. More particularly, the present disclosure relates to a weldable mount that is adapted to be welded to a fuel tank to mount a fuel tank valve assembly in a fixed position in an aperture formed in a top wall of the fuel tank.

### SUMMARY

In accordance with the present disclosure, an exterior shell made of a material that is resistant to hydrocarbon permeation is coupled to an interior base made of a weldable plastics material to provide a vent apparatus. The interior base is mounted on a fuel tank to discharge fuel tank vapor into a hose or other vapor receiver. Hydrocarbon material that is associated with fuel tank vapor in the vent apparatus and that has permeated through the interior base to reach an interface between the interior base and the exterior shell is discharged into the hose rather than being discharged into the atmosphere surrounding the vent apparatus.

Additional features of the present disclosure will become apparent to those skilled in the art upon consideration of the following detailed description of illustrative embodiments of the disclosure exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a vent apparatus in accordance with a first embodiment of the disclosure;

FIG. 2 is a sectional view taken along line 2-2 of FIG. 1 showing the vent apparatus mounted in an aperture formed in a top wall of a fuel tank made of a weldable plastics material and showing a fuel tank vapor discharge hose coupled to a venting outlet included in the vent apparatus and defined by an inner outlet conduit and a shorter surrounding outer outlet conduit;

FIG. 3 is an enlarged sectional view of a portion of the venting outlet and mating hose of FIG. 2 diagrammatically showing permeation of hydrocarbon material through the inner outlet conduit and showing passage of that hydrocarbon material along a route at an interface between the inner outlet conduit and the surrounding outer outlet conduit to be discharged into a vent passageway formed in the hose;

FIG. 4 is a sectional view similar to FIG. 2 of a vent apparatus in accordance with a second embodiment of the disclosure;

FIG. 5 is a “diagrammatic” sectional view of a plastic injection mold having an upper mold portion and a lower mold portion, here shown spaced apart in an “opened” position, and showing an interior base made of a weldable material pre-positioned within the lower mold portion prior to closing the mold and injecting a non-weldable plastics material into a mold cavity formed in the upper and lower mold portions (in the manner shown in FIG. 6);

FIG. 6 is a sectional view similar to FIG. 5 showing the upper and lower mold portions in a closed position and a non-weldable plastics material injected into the mold cavity through a channel formed in the upper mold portion so as to “overmold” non-weldable plastics material onto the interior base to form an exterior shell coupled to the interior base;

FIG. 7 is a sectional view similar to FIGS. 2 and 4 of a vent apparatus in accordance with a third embodiment of the disclosure; and

FIG. 8 is a diagrammatic view of a system using two of the vent apparatus shown in FIG. 7 to conduct fuel vapor from one fuel tank to another fuel tank.

### DETAILED DESCRIPTION OF THE DRAWINGS

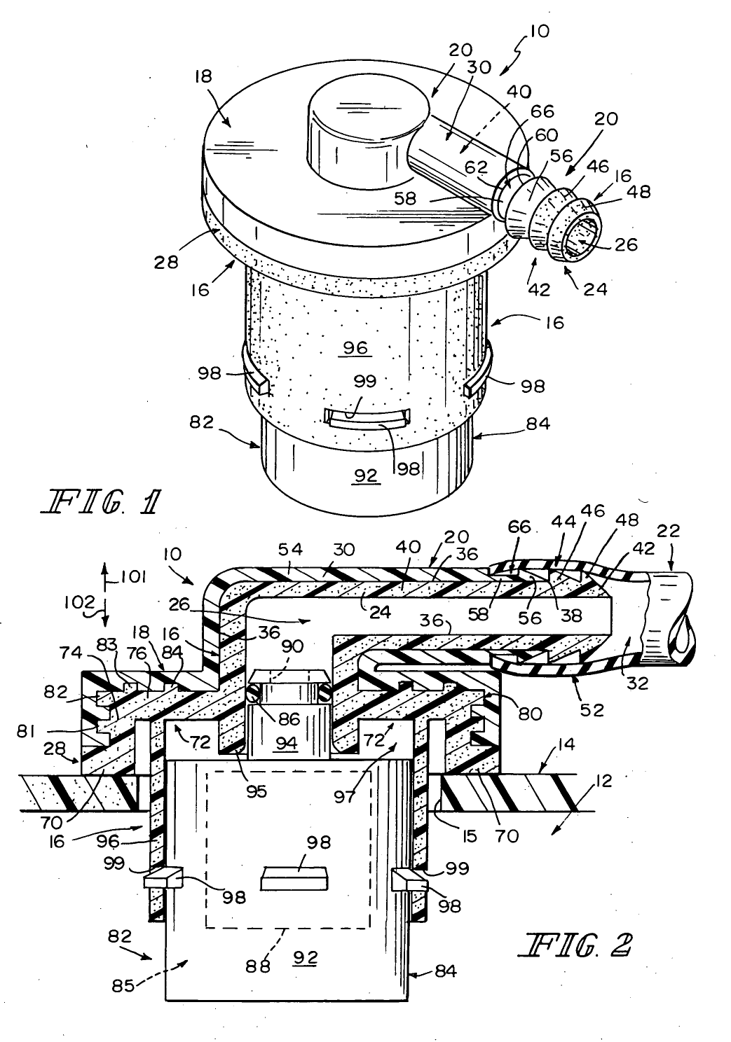

A vent apparatus 10 is shown, for example, in FIG. 1 and is used as suggested in FIG. 2 to conduct fuel tank vapor from an interior region 12 of a fuel tank 14 to a destination outside of fuel tank 14 without emitting hydrocarbon materials associated with fuel tank vapor flowing through vent apparatus 10 to the atmosphere at levels in excess of governmental emission regulations. Vent apparatus 10 includes an interior base 16 made of a weldable plastics material and adapted to be coupled to fuel tank 14 at a mounting aperture 15 formed in fuel tank 14. Vent apparatus 10 also includes an exterior shell 18 made of a non-weldable plastics material that is resistant to hydrocarbon permeation and coupled to interior base 16 to shield portions of interior base 16 from exposure to the atmosphere surrounding vent apparatus 10 and fuel tank 14. Exterior shell 18 acts as a shield that is resistant to hydrocarbon permeation to block hydrocarbon emission that permeates through the weldable plastics material used to make interior base 16 from escaping to the atmosphere surrounding vent apparatus 10.

Interior base 16 and exterior shell 18 cooperate to define a venting outlet 20 that is coupled to a separate vapor discharge hose 22 as suggested in FIG. 2. Hose 22 functions to conduct fuel tank vapor discharged from fuel tank 14 through mounting aperture 15 via venting outlet 20 to a destination outside fuel tank 14. Hose 22 is made, for example, of a nylon material.

Interior base 16 includes an inner outlet conduit 24 formed to include a vent passageway 26 and a tank mount 28 coupled to inner outlet conduit 24 as suggested, for example, in FIG. 2. In the illustrated embodiment, tank mount 28 is adapted to be coupled to fuel tank 14 at mounting aperture 15 to allow flow of fuel tank vapor in fuel tank 14 through mounting aperture 15 into vent passageway 26 formed in inner outlet conduit 24.

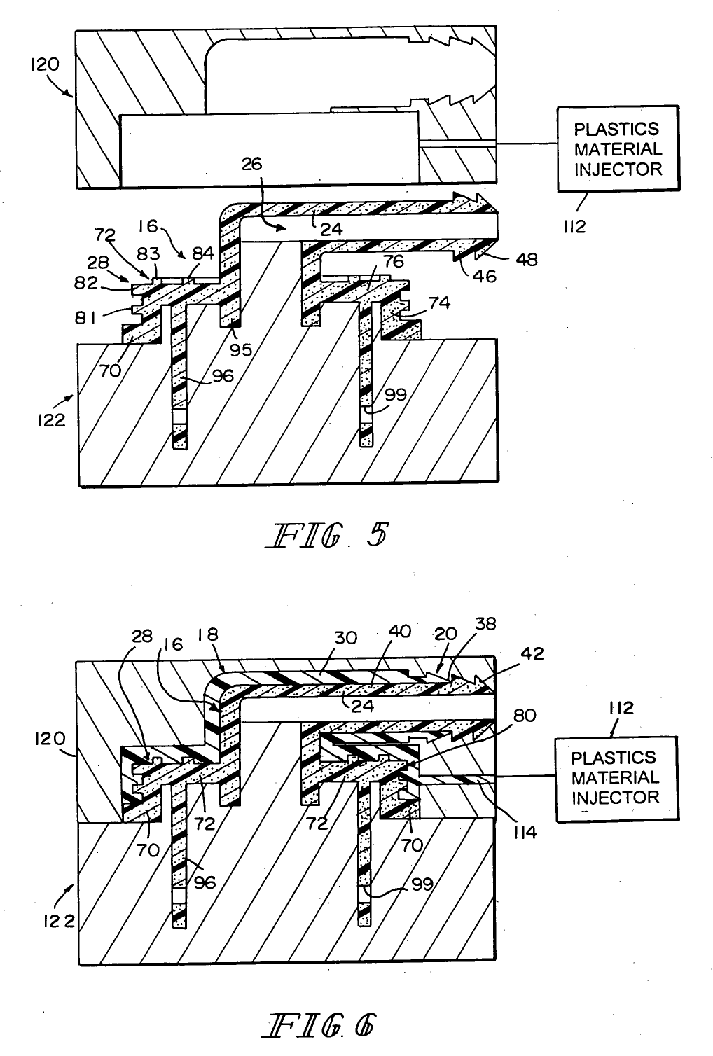

Exterior shell 18 is coupled to interior base 16 as suggested, for example, in FIG. 2 to define an outer outlet conduit 30 engaging and surrounding a portion of inner outlet conduit 24. Inner and outer outlet conduits 24, 30 cooperate to form venting outlet 20 as suggested, for example, in FIG. 2. Illustratively, exterior shell 18 is “overmolded” onto interior base 16 as suggested in FIGS. 5 and 6.

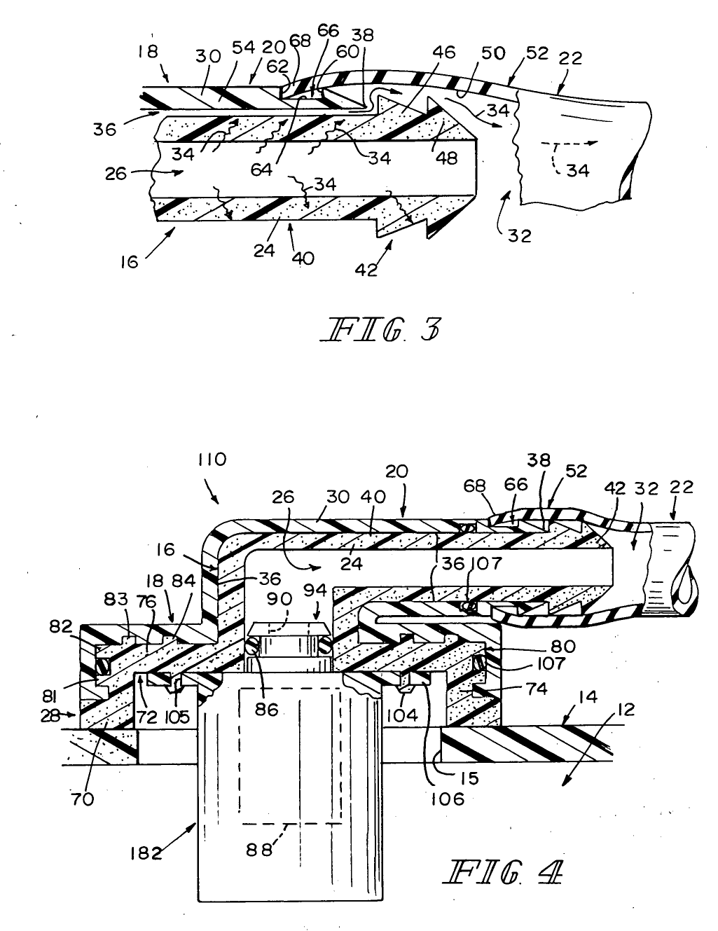

Vapor discharge hose 22 is formed to include a vapor-conducting passageway 32 and coupled to outer outlet conduit 30 as suggested in FIG. 2 to establish a sealed connection therebetween as shown in FIGS. 2 and 3. Vent passageway 26 formed in inner outlet conduit 24 is placed in fluid communication with vapor-conducting passageway 32 formed in vapor discharge hose 22. This arrangement causes any hydrocarbon material associated with fuel tank vapor 34 in vent passageway 26 that has (1) permeated through inner outlet conduit 24 to reach an interface 36 between inner and outer outlet conduits 24, 30 and (2) moved toward vapor discharge hose 22 along interface 36 to be discharged into vapor-conducting passageway 32 formed in vapor discharge hose 22 as suggested diagrammatically in FIG. 3.

Outer outlet conduit 30 is formed to include a terminal opening 38. Inner outlet conduit 24 extends through terminal opening 38 to define a shielded portion 40 surrounded by outer outlet conduit 30 and an exposed portion 42 located outside of outer outlet conduit 30 as suggested, for example, in FIGS. 2 and 3. Vapor discharge hose 22 is coupled to outer outlet conduit 30 to locate exposed portion 42 in vapor-conducting passageway 32 of vapor discharge hose 22. Vapor discharge hose 22 is also coupled to and arranged to surround exposed portion 42 as suggested at 44 in FIG. 2 to establish a sealed connection therebetween to block flow of fuel tank vapor in vapor-conducting passageway 32 into the atmosphere along an interface between exposed portion 42 of inner outlet conduit 24 and vapor discharge hose 22.

As shown, for example, in FIGS. 1-3, exposed portion 42 of inner outlet conduit 24 includes first and second frustoconical annular hose mounts 46, 48 located in vapor-conducting passageway 32 formed in vapor discharge hose 22. These hose mounts 46, 48 are arranged in series to engage an inner wall 50 of a surrounding portion 52 of vapor discharge hose 22 to establish the sealed connection (at 44) between vapor discharge hose 22 and exposed portion 42 of inner outlet conduit 24.

As shown best in FIG. 3, outer outlet conduit 30 includes a sleeve 54 surrounding shielded portion 40 of inner outlet conduit 24, a frustoconical annular hose mount 56 defining terminal opening 38, and an annular collar 58 interconnecting sleeve 54 and hose mount 56. Annular collar 58 surrounds shielded portion 40 of inner outlet conduit 24. An annular face 60 of hose mount 56 cooperates with an annular face 62 of sleeve 54 and an exterior wall 64 of annular collar 58 to define a radially outwardly opening annular channel 66. A distal end 68 of vapor discharge hose 22 extends into radially outwardly opening annular channel 66 to engage annular face 62 of sleeve 54. As suggested in FIGS. 1 and 2, inner wall 50 of vapor discharge hose 22 is arranged to surround and engage each of the three radially extending annular hose mounts 56, 46, and 48.

As suggested in FIGS. 1 and 2, tank mount 28 of vent apparatus 10 also includes an annular foundation 70 and a shell platform 72. Annular foundation 70 is adapted to be coupled to fuel tank 14 (as by, e.g., welding) at mounting aperture 15. A hot-plate welding process can be used to couple annular foundation 70 to fuel tank 14 to provide a low-permeation joint therebetween to minimize unwanted fuel tank vapor leakage therebetween. Shell platform 72 is arranged to extend between annular foundation 70 and inner outlet conduit 24 and to mate with exterior shell 18 as shown in FIG. 2.

Shell platform 72 includes a vertical ring 74 and a horizontal ring 76. Vertical ring 74 extends upwardly from annular foundation 70 as suggested in FIG. 2. Horizontal ring 76 extends laterally from vertical ring 74 to inner outlet conduit 24.

Exterior shell 18 further includes a tank mount cover 78 coupled to outer outlet conduit 30. Tank mount cover 78 is formed to include a chamber containing vertical and horizontal rings 74, 76 as suggested in FIGS. 1 and 2. Annular foundation 70 of tank mount 28 lies outside the ring-receiving chamber formed in tank mount cover 78 as suggested in FIGS. 1 and 2.

Tank mount 28 further includes a plurality of annular flanges 81, 82, 83, and 84 appended to exterior surfaces of vertical and horizontal rings 74, 76. Annular flanges 81-84 are arranged to lie in series and in spaced-apart relation to one another and in mating relation to an inner surface of tank mount 28 to define a labyrinthine boundary 80 between tank mount cover 78 and vertical and horizontal rings 74, 76 of tank mount 28 as suggested in FIG. 2. Labyrinthine boundary 80 establishes a low-permeation joint between exterior shell 18 and interior base 16. Reference is hereby made to U.S. Pat. No. 6,662,820, the disclosure of which is incorporated herein, for a description of a low-permeation joint established by a labyrinthine boundary between weldable and non-weldable plastics materials.

A vent controller 82 is included in vent apparatus 10 as suggested, for example, in FIGS. 2 and 4. Vent controller 82 is configured to regulate flow of fuel vapor from interior region 12 of fuel tank 14 into vent passageway 26 formed in inner outlet conduit 24 of venting outlet 20.

As suggested in FIG. 2, vent controller 82 includes a valve housing 84, an O-ring seal 86 coupled to valve housing 84, and a valve 88 located in valve housing 84. O-ring seal 86 is positioned to establish a sealed connection between valve housing 84 and interior base 16. Valve 88 is arranged to move relative to valve housing 84 to regulate flow of fuel tank vapor into vent passageway 26.

Valve housing 84 is coupled to interior base 16 and formed to include an interior region 85 receiving fuel tank vapor from interior region 12 of fuel tank 14. Valve housing 84 is also formed to include a venting aperture 90 communicating with interior region 85 and opening into vent passageway 26 formed in inner outlet conduit 24 as suggested in FIG. 2.

Valve 88 is positioned to lie within interior region 85 of valve housing 84 as suggested diagrammatically in FIG. 2. Valve 88 is arranged to move within interior region 85 to open and close venting aperture 90 to regulate flow of fuel tank vapor into vent passageway 26 formed in inner outlet conduit 24.

In the illustrated embodiments, valve housing 84 includes a valve receiver 92 and a receiver outlet 94 coupled to valve receiver 92. Valve receiver 92 and receiver outlet 94 cooperate to define interior region 85 of valve housing 84. Receiver outlet 94 is a tubular member configured to carry O-ring seal 86 on an exterior surface thereof as suggested in FIG. 2. Receiver outlet 94 extends into an outlet sleeve 95 providing a portion of inner outlet conduit 24 as suggested in FIG. 2.

Interior base 16 further includes a vent controller support 96 arranged to depend from shell platform 72 of tank mount 28 as shown, for example, in FIG. 2. In the embodiment shown in FIG. 2, tank mount 28, inner outlet conduit 24, and vent controller support 96 cooperate to form a monolithic interior base 16 made of a weldable plastics material such as high-density polyethylene (HDPE). Vent controller support 96 is formed to include a housing chamber 97 containing a portion of valve housing 84 therein as shown, for example, in FIG. 2.

Vent controller 82 further includes retainers 98 coupled to valve receiver 92 as shown, for example, in FIG. 2. These retainers 98 are configured and arranged to extend into retainer receivers 99 formed in vent controller support 96 as shown, for example, in FIGS. 1 and 2 so that vent controller 82 is retained in a fixed position relative to interior base 16 and, illustratively, in housing chamber 97 of vent controller support 96. Vent controller support 96 is coupled to an underside of horizontal ring 76 and arranged to lie in concentric relation to vertical ring 74 as suggested in FIG. 2. In the illustrated embodiment, vent controller support 96 has a cylindrical shape.

As shown in FIG. 2, a first portion of inner outlet conduit 24 is arranged to extend upwardly from horizontal ring 76 of shell platform 72 in a direction 101 away from vent controller support 96 and to mate with annular or O-ring seal 86. A second portion of inner outlet conduit 24 is arranged to extend downwardly from horizontal ring 76 of shell platform 72 in direction 102 into housing chamber 97 formed in vent controller support 96. These first and second portions cooperate to define outlet sleeve 95.

In an embodiment illustrated in FIG. 4, a vent apparatus 110 includes a vent controller 182 that is separate from but coupled to tank mount 28 using any suitable means. For example, mounting posts 104 depend from horizontal ring 76 of shell platform 72 and extend into apertures 105 formed in a mounting flange 106 included in vent controller 182. Mounting posts 104 are coupled to mounting flange 106 to retain vent controller 182 in a fixed position relative to tank mount 28 as suggested in FIG. 4. It is within the scope of this disclosure to locate O-ring seals 107 as needed along an interface between interior base 16 and exterior shell 18 as shown, for example, in FIG. 4.

One method of mating exterior shell 18 to interior base 16 is illustrated diagrammatically in FIGS. 5 and 6. A plastics material injector 112 is used to introduce a non-weldable plastics material 114 into a mold cavity containing interior base 16 and defined in upper and lower mold portions 120, 122. The shrink and pack pressure of the non-weldable material comprising exterior shell 18 creates an initial seal between the dissimilar materials in exterior shell 18 and interior base 16. The geometry of the interface between exterior shell 18 and interior base 16 uses a “fuel swell” characteristic of the weldable plastics material to increase the tightness or compression of the interface. In cases where this swell is not sufficient, O-ring seals 107 as shown in FIG. 4 can be used. Reference is hereby made to U.S. Pat. Nos. 6,308,735 and 6,662,820, the disclosures of which is incorporated in its entirety herein, for descriptions of a process for overmolding a non-weldable plastics material onto a weldable plastics material.

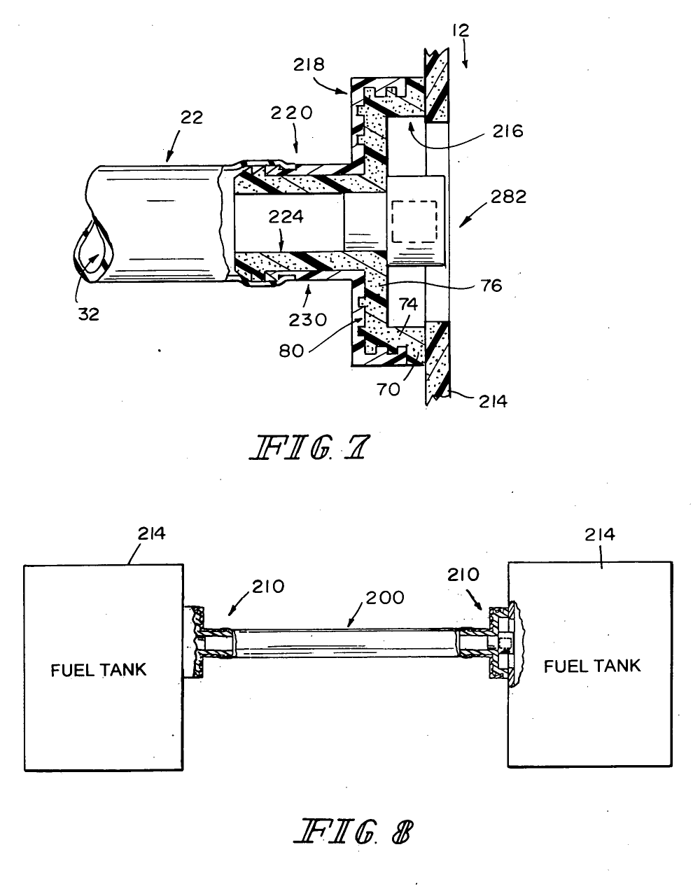

In the embodiment illustrated in FIGS. 7 and 8, a vent apparatus 210 including interior base 217 and exterior shell 218 can be mounted on two fuel tanks 214 and coupled to a hose 200 extending between fuel tanks 214 to communicate fuel tank vapor and/or send liquid fuel between fuel tanks 214. Vent apparatus 210 can be used for any communication to fuel tank 214 required to have low hydrocarbon permeation. Venting outlet 220 includes an inner outlet conduit 224 and an outer outlet conduit 230. It is within the scope of this disclosure to include a vent controller 282 in vent apparatus 210 if desired; however, it is expected that normally such a vent controller 282 would be included in a dual-tank system as shown, for example, in FIG. 8.

A vent apparatus 10, 110, or 210 in accordance with the present disclosure addresses the issue of hydrocarbon permeation through high-density polyethylene (HDPE) or other weldable plastics material by minimizing the portion of HDPE exposed to the atmosphere. The overmolded exterior shell exposes just enough HDPE reliably to complete a heat weld between the vent apparatus and the fuel tank, while minimizing the remaining exposed HDPE with the use of a hydrocarbon-permeation barrier material (such as a non-weldable plastics material).

1. A vent apparatus adapted to be coupled to a fuel tank, the apparatus comprising
an interior base made of a weldable plastics material, the interior base including an inner outlet conduit formed to include a vent passageway and a tank mount adapted to be coupled to a fuel tank at a mounting aperture formed in the fuel tank to allow flow of fuel tank vapor in the fuel tank through the mounting aperture into the vent passageway formed in the inner outlet conduit,
a vent controller including a valve housing coupled to the interior base and formed to include an interior region receiving fuel tank vapor and a venting aperture communicating with the interior region and opening into the vent passageway formed in the inner outlet conduit, the vent controller also including a valve positioned to lie within the interior region of the valve housing and arranged to move within the interior region to open and close the venting aperture to regulate flow of fuel tank vapor into the vent passageway formed in the inner outlet conduit, and
an exterior shell made of a non-weldable plastics material and coupled to the interior base to define an outer outlet conduit engaging and surrounding a portion of the inner outlet conduit.

2. The apparatus of claim 1, further comprising a vapor discharge hose formed to include a vapor-conducting passageway and coupled to the outer outlet conduit to establish a sealed connection therebetween and to place the vent passageway formed in the inner outlet conduit in fluid communication with the vapor-conducting passageway formed in the vapor discharge hose and to cause any hydrocarbon material associated with fuel tank vapor in the vent passageway that has permeated through the inner outlet conduit to reach an interface between the inner and outer outlet conduits and moved toward the vapor discharge hose along the interface between the inner and outer outlet conduits to be discharged into the vapor-conducting passageway formed in the vapor discharge hose.

3. The apparatus of claim 2, wherein the outer outlet conduit is formed to include a terminal opening and the inner outlet conduit extends through the terminal opening to define a shielded portion surrounded by the outer outlet conduit and an exposed portion located outside of the outer outlet conduit and the vapor discharge hose is coupled to the outer outlet conduit to locate the exposed portion in the vapor-conducting passageway of the vapor discharge hose.

4. The apparatus of claim 2, wherein the outer outlet conduit is formed to include a terminal opening and the inner outlet conduit extends through the terminal opening to define a shielded portion surrounded by the outer outlet conduit and an exposed portion located outside of the outer outlet conduit and the vapor discharge hose is coupled to and arranged to surround the exposed portion of the inner outlet conduit to establish a sealed connection therebetween to block flow of fuel tank vapor in the vapor-conducting passageway to the atmosphere along an interface between the exposed portion of the inner outlet conduit and the vapor discharge hose.

5. The apparatus of claim 4, wherein the exposed portion of the inner outlet conduit includes first and second frustoconical annular hose mounts located in the vapor-conducting passageway formed in the vapor discharge hose and arranged in series to engage an inner wall of a surrounding portion of the vapor discharge hose to establish the sealed connection between the vapor discharge hose and the exposed portion of the inner outlet conduit.

6. The apparatus of claim 4, wherein the outer outlet conduit includes a sleeve surrounding the shielded portion of the inner outlet conduit, a frustoconical annular hose mount defining the terminal opening, and an annular collar interconnecting the sleeve and the frustoconical annular hose mount and surrounding the shielded portion of the inner outlet conduit, an annular face of the frustoconical annular hose mount cooperates with an annular face of the sleeve and an exterior wall of the annular collar to define a radially outwardly opening annular channel, and a distal end of the vapor discharge hose extends into the radially outwardly opening annular channel to engage the annular face of the sleeve.

7. The apparatus of claim 4, wherein the outer outlet conduit includes a first radially outwardly extending annular hose mount defining the terminal opening, the exposed portion of the inner outlet conduit includes a second radially outwardly extending annular hose mount defining a section of the vent passageway and an adjacent third radially outwardly extending annular hose mount defining another section of the vent passageway, and the vapor discharge hose includes an inner wall formed to define the vapor-conducting passageway and arranged to surround and engage each of the first, second, and third radially extending annular hose mounts.

8. The apparatus of claim 2, wherein the outer outlet conduit includes a sleeve surrounding a portion of the inner outlet conduit, a frustoconical annular hose mount at a distal end of the outer outlet conduit, and an annular collar interconnecting the sleeve and the frustoconical annular hose mount, and the annular collar and frustoconical annular hose mount cooperate to define an annular channel receiving a distal end of the vapor discharge hose.

9. The apparatus of claim 8, wherein the inner outlet conduit extends through a terminal opening into the vapor-conducting passageway formed in the vapor discharge hose.

10. The apparatus of claim 1, wherein the tank mount further includes an annular foundation adapted to be coupled to the fuel tank at the mounting aperture and a shell platform arranged to extend between the annular foundation and the inner outlet conduit and to mate with the exterior shell and the interior base further includes a vent controller support arranged to depend from the shell platform and formed to include a housing chamber containing a portion of the valve housing therein.

11. The apparatus of claim 10, wherein the shell platform includes a vertical ring extending upwardly from the annular foundation and a horizontal ring extending laterally from the vertical ring to the inner outlet conduit and the exterior shell further includes a tank mount cover coupled to the outer outlet conduit and formed to include a chamber containing the vertical and horizontal rings.

12. The apparatus of claim 11, wherein the annular foundation of the tank mount lies outside the chamber formed in the tank mount cover.

13. The apparatus of claim 11, wherein the tank mount further includes a plurality of annular flanges appended to exterior surfaces of the vertical and horizontal rings and arranged to lie in series in spaced-apart relation to one another and in mating relation to an inner surface of the tank mount to define a labyrinthine boundary between the tank mount cover and the vertical and horizontal rings of the tank mount.

14. The apparatus of claim 11 wherein the vent controller support is coupled to an underside of the horizontal ring and arranged to lie in concentric relation to the vertical ring.

15. The apparatus of claim 9, wherein the vent controller support has a cylindrical shape and is formed to include retainer receivers and the valve housing includes a valve receiver formed to include the interior region and a retainer coupled to the valve receiver and arranged to extend into one of the retainer receivers to retain the valve receiver in a fixed position in the housing chamber of the vent controller support.

16. The apparatus of claim 15, wherein the valve housing further includes a receiver outlet arranged to extend upwardly from the valve receiver and into the vent passageway formed in the inner outlet conduit, the receiver outlet is formed to include a venting aperture to allow flow of fuel tank vapor from the interior region of the valve housing into the vent passageway of the inner outlet conduit via the venting aperture, and the valve housing further includes an annular seal arranged to establish a sealed connection between the receiver outlet and the inner outlet conduit.

17. The apparatus of claim 10, wherein the valve housing includes a receiver outlet arranged to extend upwardly into the vent passageway formed in the inner outlet conduit, the receiver outlet is formed to include a venting aperture to allow flow of fuel tank vapor from the interior region of the valve housing into the vent passageway of the inner outlet conduit via the venting aperture, and the valve housing further includes an annular seal arranged to establish a sealed connection between the receiver outlet and the inner outlet conduit.

18. The apparatus of claim 17, wherein a first portion of the inner outlet conduit is arranged to extend upwardly from the shell platform in a direction away from the vent controller support and to mate with the annular seal and a second portion of the inner outlet conduit is arranged to extend downwardly from the shell platform into the housing chamber formed in the vent controller support.

19. The apparatus of claim 10, wherein the exterior shell further includes a tank mount cover coupled to the outer outlet conduit and the tank mount further includes a plurality of annular flanges appended to an exterior surface of the shell platform and arranged to lie in series in spaced-apart relation to one another and in mating relation to an inner surface of the tank mount cover to define a labyrinthine boundary between the tank mount cover of the exterior shell and the shell platform of the interior base.

20. The apparatus of claim 19, wherein the exterior shell is a monolithic member and the interior base is a monolithic member.

21. A vent apparatus adapted to be coupled to a fuel tank, the apparatus comprising
an interior base made of a weldable plastics material, the interior base including an inner outlet conduit formed to include a vent passageway and a tank mount adapted to be coupled to a fuel tank at a mounting aperture formed in the fuel tank to allow flow of fuel tank vapor through the mounting aperture into the vent passageway formed in the inner outlet conduit, and
an exterior shell made of a non-weldable plastics material and coupled to the interior base, the exterior shell including a tank mount cover arranged to engage and cover an exterior surface of the tank mount, the exterior shell further including an outer outlet conduit coupled to the tank mount cover and arranged to engage and surround a portion of the inner outlet conduit.

22. The apparatus of claim 21, wherein the exterior shell is a monolithic member and the interior base is a monolithic member.

23. The apparatus of claim 21, wherein a vapor discharge hose is formed to include a vapor-conducting passageway and coupled to the outer outlet conduit to establish a sealed connection therebetween and to place the vent passageway formed in the inner outlet conduit in fluid communication with the vapor-conducting passageway formed in the vapor discharge hose and to cause any hydrocarbon material associated with fuel tank vapor in the vent passageway that has permeated through the inner outlet conduit to reach an interface between the inner and outer outlet conduits and moved toward the vapor discharge hose along the interface between the inner and outer outlet conduits to be discharged into the vapor-conducting passageway formed in the vapor discharge hose.

24. The apparatus of claim 21, further comprising a vapor discharge hose formed to include a vapor-conducting passageway and wherein the outer outlet conduit is formed to include a terminal opening, the inner outlet conduit extends through the terminal opening to define a shielded portion surrounded by the outer outlet conduit and an exposed portion located outside of the outer outlet conduit, and the vapor discharge hose is coupled to the outer outlet conduit to locate the exposed portion of the inner outlet conduit in the vapor-conducting passageway of the vapor discharge hose.

25. The apparatus of claim 21, wherein the tank mount further includes an annular foundation adapted to be coupled to the fuel tank at a the mounting aperture and a shell platform arranged to interconnect the annular foundation and the inner outlet conduit and the tank mount cover is arranged to engage and cover an exterior surface of the shell platform.

26. The apparatus of claim 25, wherein the shell platform further includes a vertical ring extending upwardly from the annular foundation and a horizontal ring extending laterally from the vertical ring to the inner outlet conduit.

27. The apparatus of claim 21, wherein the tank mount further includes a plurality of annular flanges appended to exterior surfaces of the vertical and horizontal rings and arranged to lie in series in spaced-apart relation to one another and in mating relation to an inner surface of the tank mount to define a labyrinthine boundary between the tank mount cover and the vertical and horizontal rings of the tank mount.

28. The apparatus of claim 21, wherein each of the inner and outer outlet conduits are L-shaped.

29. The apparatus of claim 28, wherein the outer outlet conduit is formed to include a terminal opening and the inner outlet conduit extends through the terminal opening to define a shielded portion surrounded by the outer outlet conduit and an exposed portion located outside of the outer outlet conduit.

30. A vent apparatus adapted to be coupled to a fuel tank, the apparatus comprising
an exterior shell made of a non-weldable plastics material, the exterior shell including a tank mount cover formed to include a downwardly opening chamber having a top opening, the exterior shell further including an outer outlet conduit coupled to the tank mount cover at the top opening and formed to include a terminal outlet, and
an interior base made of a weldable plastics material and arranged to engage inner surfaces of the tank mount cover and the outer outlet conduit, the interior base including a tank mount including an annular foundation adapted to be coupled to a fuel tank at a mounting aperture formed in the fuel tank, an inner outlet conduit coupled to the tank mount and arranged to extend through the outer outlet conduit and the terminal opening thereof to define an exposed portion of the inner outlet conduit located outside of the outer outlet conduit, and a shell platform located in the downwardly opening chamber and arranged to interconnect the annular foundation and the inner outlet conduit and to engage inner surfaces of the tank mount cover.
